(19) United States
(12) Patent Application Publication
(10) Pub. No.: US 2011/0272371 A1
(43) Pub. Date: Nov. 10, 2011

(54) BAG HOLDER APPARATUS

(76) Inventor: Ben PETTIFER, Maidenhead (GB)

(21) Appl. No.: 12/773,014

(22) Filed: May 4, 2010

(51) Int. Cl. B60R 7/08; B65D 85/00; F16M 13/02

(52) U.S. Cl. 211/85.15; 248/95; 206/320

(57) ABSTRACT

Bag holder apparatus for a boot of a car, comprises a collapsible frame having an adjustable bag hanging element and two adjustable legs at each end of the bag hanging element for holding the bag hanging element in spaced relationship relative to a supporting surface. The bag hanging element is elongate and has a plurality of, preferably lockable, pivotable joints for pivoting in a common plane and which are spaced along its longitudinal extent. At least one bag retaining element is also provided intermediate two consecutive said pivotable joints. The bag retaining element is rotatable about the longitudinal axis of the bag hanging element, and retaining means are provided for releasably holding the bag retaining element in at least two angularly spaced positions about the bag hanging element.

The present invention relates to bag holder apparatus for a vehicle, and in particular but not necessarily exclusively for a boot of a car.

### BACKGROUND OF THE INVENTION

When using a car for transporting shopping, for example, from a supermarket, multiple bags are loaded with bought items which are then placed in a boot of the car. The bags are unsupported and thus spill their contents when the car accelerates, decelerates and/or turns.

The intention by shops, especially supermarkets, is to phase out supplying plastic bags, thus encouraging customers to bring their own bags. To this end, customers are now utilising more substantial shopping bags which have the disadvantage that the material is resilient enough to prohibit tying of the handles together in an effort to prevent spillage. Consequently, and since the resilient reusable bags are more substantial and often taller, increased spillage often occurs during transport.

The present invention seeks to provide a solution to this problem.

### SUMMARY OF THE INVENTION

According to the invention, there is provided bag holder apparatus for a boot of a car, the apparatus comprising a collapsible frame having an adjustable bag hanging element and two adjustable legs at each end of the bag hanging element, the bag hanging element being elongate and having a plurality of pivotable joints in a common plane and which are spaced along a longitudinal extent of the bag hanging element, at least one bag retaining element being intermediate two consecutive said pivotable joints, the bag retaining element being rotatable about the longitudinal axis of the bag hanging element, and a releasable retaining device on the bag retaining element, wherein the retaining device can hold the bag retaining element in at least two angularly spaced positions about the bag hanging element.

The present invention will now be more particularly described, by way of example only, with reference to the accompanying drawings.

### BRIEF DESCRIPTION OF THE DRAWINGS

FIG. 1 shows a perspective view of one embodiment of bag holder apparatus, in accordance with the present invention;

FIG. 2 shows an elevational view of two adjustable legs of the apparatus;

FIG. 3 is a perspective view of a bag retaining element of the apparatus, shown in phantom in three positions;

FIG. 4 shows the apparatus in use in the boot of a car;

FIG. 5 shows the apparatus in use and in isolation for clarity;

FIG. 6 shows the apparatus when collapsed for storage; and

FIG. 7 is a perspective view of a storage container for the apparatus.

### DESCRIPTION OF THE PREFERRED EMBODIMENTS

Referring to the drawings, there is shown bag holder apparatus 10 which comprises a collapsible frame 12 having an adjustable bag hanging element 14, two adjustable legs 16 at each end of the bag hanging element 14, and a plurality of bag retaining elements 18 spaced along the longitudinal extent of the bag hanging element 14.

The bag hanging element 14 is elongate and includes a plurality of pivotable joints 20 also spaced along the longitudinal extent thereof. Each joint 20 allows articulation in only two dimensions, and all of the joints 20 are arranged to provide articulation only in a single common plane.

Each joint 20 also includes retaining means 22 for releasably holding the joint 20 at a user-selectable angle. The retaining means 22 can conveniently include complementary toothed portions provided on opposing bearing surfaces of a hinge of the joint 20. The toothed portions interengage and ride over each other to provide resistance against movement.

Preferably, however, each joint 20 is releasably lockable. For example, a spring-biased retaining pip and recess can be used, or a user-rotatable locking knob with screw.

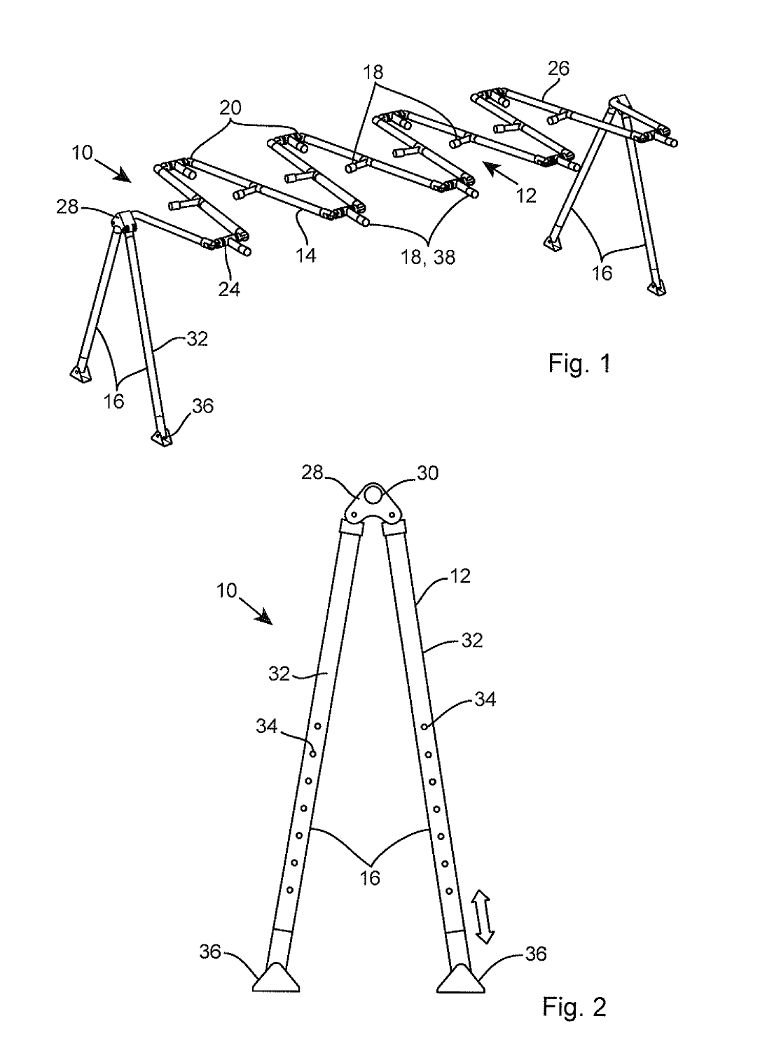

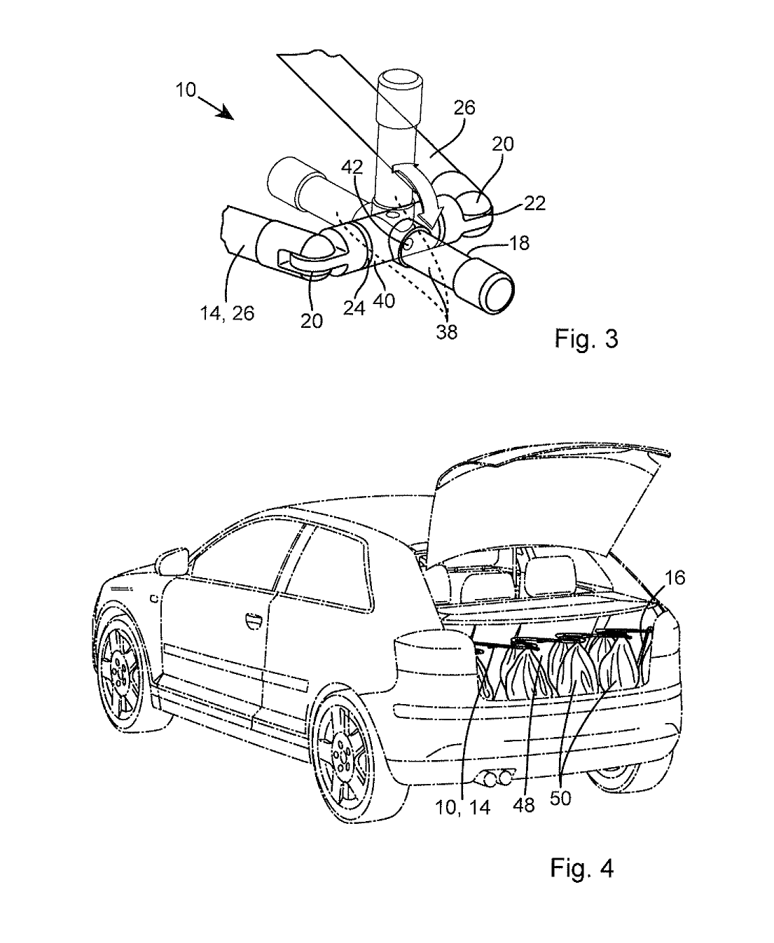

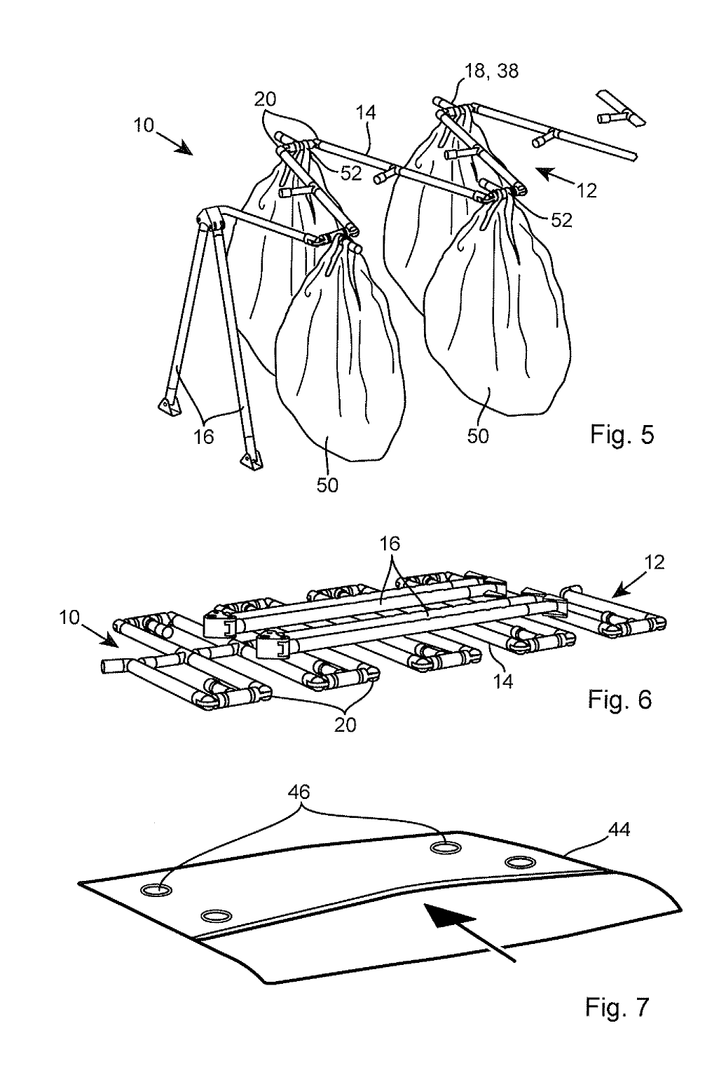

In addition to the joints 20, the bag hanging element 14 also includes a plurality of elongate rigid sections 24, 26, typically being formed from hollow tubular metal pipe, which extend between the joints 20. Adjacent sections 24, 26 are of different lengths, in this case being a plurality of rectilinear short sections 24 and a plurality of long sections 26. The long sections 26 are rectilinear aside from the two end sections which include a cranked portion for engagement with the legs 16. The short and long sections 24, 26 alternate, thus allowing the bag hanging element 14 to be extendable by pivoting of the joints 20 and allowing adoption of a zigzag configuration as shown in FIG. 1.

To space the bag hanging element 14 away from a supporting surface, the legs 16 are provided at opposite ends thereof. The legs 16 are preferably removable for compact flat-pack storage of the apparatus 10, as shown in FIG. 6, but may equally be foldable to achieve the same result.

A common leg housing 28, preferably being moulded plastics, is provided with a socket 30 for receiving an end of the bag hanging element 14. The socket 30 and end of the bag hanging element 14 may be non-circular to prevent relative rotation, and/or include a fixing screw or other element for interconnecting the two parts. Preferably, the leg housing 28 is quickly releasable from the end of the bag hanging element 14 for collapsible storage.

A leg element 32 is pivotably attached to opposite sides of the leg housing 28. A pivot axis of each leg element 32 is parallel to a depth of the socket 30. Each leg element 32 is preferably telescopic, having a leg detent 34, such as a depressible spring-biased pip and spaced apertures, to releasably fix the respective leg element 32 at a user-selectable position.

A, typically moulded plastics, foot 36 is also preferably provided at a distal end of each leg element 32, remote from the leg housing 28. The foot 36 includes a grip on a lowermost surface thereof, and is pivotable so as to accommodate a set angular position of the leg element 32.

In this embodiment, one bag retaining element 18 is provided intermediate two consecutive joints 20. The bag retaining element 18 includes an elongate rigid rectilinear bag arm 38 which projects at right angles from its respective section 24, 26 of the bag hanging element 14. Preferably, each consecutive bag arm 38 is spaced by a different amount from its adjacent joint 20. Each bag arm 38 may be provided midway between its two adjacent joints 20, or one or more of the bag arms 38 may be offset. This latter case may be beneficial in enabling more compact storage, and by preventing clashing or impingement of bag arms 38 during use.

Each bag arm 38 is rotatable relative to the longitudinal axis of the bag hanging element 14. To provide for this, each bag retaining element 18 includes a sleeve 40 which is slidably and rotatably received on a respective section 24, 26 of the bag hanging element 14. The respective bag arm 38 is attached to the sleeve 40. The bag retaining element 18 also includes retaining means 42 for releasably holding the bag arm 38 in at least two angularly spaced positions on the circumference of the bag hanging element 14. The retaining means 42 is a releasable detent, such as a depressible spring-biased pip on the section 24, 26 of the bag hanging element 14 and circumferentially-spaced apertures on the sleeve 40 of the bag retaining element 18. The two angularly-spaced positions are preferably 180 degrees apart. A further angularly-spaced position may also be provided intermediate the two other angularly-spaced positions. In this case, the three angularly-spaced positions are spaced apart by 90 degrees.

To accommodate different car widths, one or more of the sections 24, 26 of the bag hanging element 14 may be removable.

For storage, a storage container 44 can be provided. In this case, a flexible, typically fabric, container 44 is convenient. The container 44 may include attachment means 46 for releasable fastening to a rear surface of a, typically back, seat of a car or vehicle. The attachment means 46 may conveniently be one or more magnetic elements and/or a hook and loop fastener, such as Velcro®.

In use, the bag hanging element 14 is extended to or substantially to a maximum width of a car boot 48 so that the bag hanging element 14 adopts a zigzag or serpentine configuration. The adjustable legs 16 are extended so that the bag hanging element 14 is well spaced from an interior floor of the boot 48 and sufficient to suspend or substantially suspend the user's bags 50. The leg elements 32 are also pivoted away from each other to form an inverted V-shape, and so that the feet 36 are braced against corners or edges where a wall of the boot 48 meets the floor. This stabilises the apparatus 10.

To attach a bag 50, the handles 52 are looped over the bag arm 38, and the detent 42 is operated so that the bag arm 38 can be rotated around the bag hanging element 14 by 180 degrees and then releasably locked in place. This results in the bag handles 52 being drawn together also around the bag hanging element 14, effectively closing and securely engaging the bag 50 whilst spreading the load across the handles 52, unlike with hooks which concentrate the load at one point.

To remove the bag 50, the detent 42 is simply released and the bag arm 38 returned to its original starting position.

If the intermediate angular position for the bag arm is provided, then this may be suitable for some situations, but it does not close and secure the bag as fully.

By offsetting the bag retaining elements on consecutive long sections of the bag hanging element, when the bag arms are rotated over, clashing and/or impingement is avoided.

It is feasible that the bag arm may only be angularly displaceable through 90 degrees, instead of 180 degrees. Alternatively, the bar arm could be rotatable through more than 180 degrees, such as 270 degrees.

The retaining means may be different. For example, a ratchet or friction fit could be envisaged providing the weight of an attached bag was not sufficient to pull the bag arm back to its starting position or beyond.

Although only one bag retaining element is provided on each section, more than one bag retaining element can be provided. Additionally or alternatively, one or more sections of the bag hanging element may be without a bag retaining element.

When not in use, the legs can be removed or folded flat against the compacted bag hanging element, and the frame can then either lie on the floor of the boot or be stored in the above-mentioned storage container.

The bag hanging element, bag retaining elements and/or legs may be straight or curved, or a combination thereof.

It is thus possible to provide bag holder apparatus for a boot of a car or a suitable space in any vehicle. The apparatus is lightweight with few components, thus enabling simple and cost-effective manufacture. The apparatus is adaptable to almost any size of vehicle space, providing a sturdy and stable hanging frame. The rotatable bag retaining elements advantageously close and hold almost any type of shopping bag, including the sturdier reusable bags.

The embodiments described above are provided by way of examples only, and various other modifications will be apparent to persons skilled in the art without departing from the scope of the invention as defined by the appended claims.

What is claimed is:

1. Bag holder apparatus for a boot of a car, the apparatus comprising a collapsible frame having an adjustable bag hanging element and two adjustable legs at each end of the bag hanging element, the bag hanging element being elongate and having a plurality of pivotable joints in a common plane and which are spaced along a longitudinal extent of the bag hanging element, at least one bag retaining element being intermediate two consecutive said pivotable joints, the bag retaining element being rotatable about the longitudinal axis of the bag hanging element, and a releasable retaining device on the bag retaining element, wherein the retaining device can hold the bag retaining element in at least two angularly spaced positions about the bag hanging element.

2. Bag holder apparatus as claimed in claim 1, wherein the bag hanging element is zigzagged.

3. Bag holder apparatus as claimed in claim 1, wherein the bag hanging element is extendable.

4. Bag holder apparatus as claimed in claim 1, wherein each set of adjustable legs forms an inverted V-shape.

5. Bag holder apparatus as claimed in claim 1, wherein the two adjustable legs are independently angularly adjustable relative to each other.

6. Bag holder apparatus as claimed in claim 1, wherein each leg includes an angularly adjustable foot for gripping a surface of a car boot.

7. Bag holder apparatus as claimed in claim 1, wherein each said joint includes holding means for releasably locking the joint at a given angular position.

8. Bag holder apparatus as claimed in claim 1, wherein a plurality of said bag retaining element are provided, each bag retaining element being intermediate two different adjacent pivotable joints, and each bag retaining element being at a different position between its respective joints than the next bag retaining element.

9. Bag holder apparatus as claimed in claim 1, wherein the or each bag retaining element is movable in the range of 0 degrees to 180 degrees.

10. Bag holder apparatus as claimed in claim 1, wherein the retaining means is a detent.

11. Bag holder apparatus as claimed in claim 1, wherein the retaining means can releasably hold the bag retaining element in three angularly spaced positions on the bag hanging element.

12. Bag holder apparatus as claimed in claim 1, wherein the retaining means can hold the bag retaining element at positions which are spaced by or substantially by 90 degrees.

13. Bag holder apparatus as claimed in claim 1, wherein the bag hanging element includes a plurality of sections interconnected by the said pivotable joints, one or more sections being selectively removable to adjust a longitudinal extent of the bag hanging element.

14. Bag holder apparatus as claimed in claim 1, wherein the adjustable legs are detachable and/or foldable for flat-pack storage of the apparatus.

15. Bag holder apparatus as claimed in claim 1, further comprising a storage container for flat-pack storage of the apparatus.

16. Bag holder apparatus as claimed in claim 15, wherein the storage container includes attachment means for releasable attachment to a back side of a seat.

17. Bag holder apparatus as claimed in claim 16, wherein the attachment means includes at least one magnetic element.
